(19) United States
(12) Patent Application Publication
(10) Pub. No.: US 2008/0017136 A1
(43) Pub. Date: Jan. 24, 2008

(54) METHOD OF CONTROLLING COMBUSTION IN AN HCCI ENGINE

(75) Inventors: Steven Sciamanna, Orinda, CA (US); Curtis Munson, Oakland, CA (US); Gunther Dieckmann, Walnut Creek, CA (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 11/613,105

(22) Filed: Dec. 19, 2006

Related U.S. Application Data
(60) Provisional application No. 60/758,004, filed on Jan. 10, 2006.

(51) Int. Cl. F02B 43/00

(52) U.S. Cl. 123/1 A

(57) ABSTRACT

A method of controlling combustion of an air-fuel charge in a piston engine having at least one combustion chamber comprising, (a) mixing at least one hydrocarbon fluid fuel and no more than about 10,000 ppm of at least one combustion initiating additive to thereby produce a fluid fuel mixture; (b) combining the fluid fuel mixture with a gaseous medium containing oxygen thereby producing an air-fuel charge; (c) supplying the air-fuel charge to the at least one combustion chamber; (d) compressing the air-fuel charge with a piston in the at least one combustion chamber; and (e) igniting the air-fuel charge with at least one light source.

### FIELD OF THE INVENTION

The present invention is directed to a method of controlling combustion of an air-fuel charge in a piston engine having at least one combustion chamber.

### BACKGROUND OF THE INVENTION

A number of new and improved internal combustion engines are being developed to utilize low temperature combustion in an internal combustion engine; such new engines include homogenous charge compression ignition (HCCI) engines.

HCCI engines normally rely upon the compression heating to start the ignition process. Such reliance leads to difficulty in timing the ignition processes, particularly over a wide range of engine speeds which range from about 500 revolutions per minute (rpm) to about 6000 rpm. Improper timing can lead to a series of problems ranging from rough idle to serious issues, such as power loss or malfunction or destruction of the engine.

For these new engines it has been recognized that fuel characteristics also play an important role in the efficient operation of the engine. Simple parameters such as octane and cetane are insufficient to properly describe the desired fuel characteristics. It is known that pre-reaction heat release, phasing, and the ratio of pre-reaction to main reaction heat release are key characteristics of the combustion process for these new engines. One current approach in optimizing combustion characteristics is to vary the fuel composition.

However, one problem with this approach is the difficulty in maintaining the characteristics of fuels, such as gasoline and diesel fuels, at different locations within the combustion chamber and over time.

In the present invention, the timing of the heat release is controlled by the use of a reaction-enhancing combustion initiating additive, combined with a reaction initiation device or light source. This approach has the advantage of providing precise and predictable control over the important combustion timing and allows the possible use of pool gasoline and diesel fuel feedstocks.

### DESCRIPTION OF THE RELATED ART

Sutherland, U.S. Pat. No. 6,637,393 discloses a method and a means for controlling ignition timing and combustion rate in such engines. In particular a controllable heater in the engine combustion chamber is placed in a section of the chamber. Controlling the temperature of the heater in the section of the chamber may be effective to vary the energy applied to air fuel charges of varying degrees of leanness so as to provide the desired timing and combustion rate of the homogenous charges supplied to the combustion chamber under the various operating conditions of the engine.

Hiltner, U.S. Pat. No. 6,463,907 discloses a homogenous charge compression ignition (HCCI) engine and operating method, having ignition timing controlled on a cycle to cycle basis by adding to a primary fuel, which is typically greater than 95% and is a gas such as natural gas with a relatively slow burn rate, varying amounts of high cetane number fuel, typically diesel fuel, before or early in the compression stroke.

Speilman et al., U.S. Patent Application No. US 2003/0051990 A1 discloses that an intense ultraviolet radiation source may be operated in substantially any arbitrary gas environment, without regard to a containment enveloped for the ultraviolet radiation source. The intense UV light source may be used to treat waste streams containing pollutants and/or contaminants.

Iida, U.S. Pat. No. 6,640,754 discloses a method for controlling the start of combustion in an homogenous charge compression engine by forming a substantially homogenous air/fuel charge. The air/fuel charge is compressed and the air/fuel charge is auto-ignited due to the compression of the air/fuel charge.

Yang, U.S. Pat. No. 6,390,054 discloses a method of operating a hybrid homogenous-charge compression engine and a spark ignition engine. The method comprises the steps of detecting a transition request to transition engine from a current operating mode to a desired operating mode.

Yang, U.S. Pat. No. 6,345,610 discloses a device that assists in controlling the ignition timing and the combustion rate at different operating conditions in an HCCI engine. Additionally, a device is provided in an intake system of an HCCI engine wherein the device can partially oxidize fuel prior to entering a combustion chamber.

Agama et al., U.S. Pat. No. 6,668,788 discloses a method of dividing the homogenous charge, in an HCCI engines between a controlled volume higher compression space and a lower compression space to better control the start of ignition in the engine.

Shinogle et al., U.S. Pat. No. 6,959,699 discloses a method of operating an engine that comprises mixing air and fuel vapor within an injector instead of within the engine cylinder. The air/fuel mixture is then injected into the engine cylinder at some desired timing and over some desired duration. Such a strategy permits for lower emissions due to better mixing of air and fuel, while also permitting control over some aspects of combustion timing and duration not apparently possible, with a conventional HCCI strategy.

Ryan, III U.S. Patent Application No. US 2002/0185097 A1 discloses a method and apparatuses for laser ignition in an internal combustion engine. Laser radiation is directed to an ignition location within a combustion chamber with adaptive optics, and the position of the ignition location is adaptively adjusted during operation of the engine using the adaptive optics.

Mack, John H. et al., The Effect of the Di-Tertiary Butyl Peroxide (DTBP) additive on HCCI Combustion of Fuel Blends of Ethanol and Diethyl Ether, SAE Technical Paper 2005-01-2135, 2006 discloses the influence of small amounts of the additive di-tertiary butyl peroxide (DTBP) on the combustion event of Homogenous Charge Compression Ignition (HCCI) engines was investigated using engine experiments, numerical modeling, and carbon-14 isotope tracing.

### SUMMARY OF THE INVENTION

In one embodiment, the present invention is directed to a method of controlling combustion of an air-fuel charge in a piston engine having at least one combustion chamber comprising:
(a) mixing at least one hydrocarbon fluid fuel and no more than about 10,000 ppm of at least one combustion initiating additive to there by produce a fluid fuel mixture;
(b) combining the fluid fuel mixture with a gaseous medium containing oxygen thereby producing an air-fuel charge;
(c) supplying the air-fuel charge to the at least one combustion chamber;
(d) compressing the air-fuel charge with a piston in the at least one combustion chamber; and
(e) igniting the air-fuel charge with at least one light source.

In another embodiment, the present invention is directed to a method of controlling combustion of an air-fuel charge in a piston engine having at least one combustion chamber comprising:
(a) mixing at least one hydrocarbon fluid fuel and no more than about 10,000 ppm of at least one combustion initiating additive to thereby produce a fluid fuel mixture;
(b) supplying a gaseous medium containing oxygen to the at least one combustion chamber;
(c) supplying the fluid fuel mixture to the at least one combustion chamber and mixing the fluid fuel mixture with the gaseous medium containing oxygen thereby producing an air-fuel charge;
(d) compressing the air-fuel charge with a piston in the at least one combustion chamber; and
(e) igniting the air-fuel charge with a light source.

### DETAILED DESCRIPTION OF THE DRAWINGS

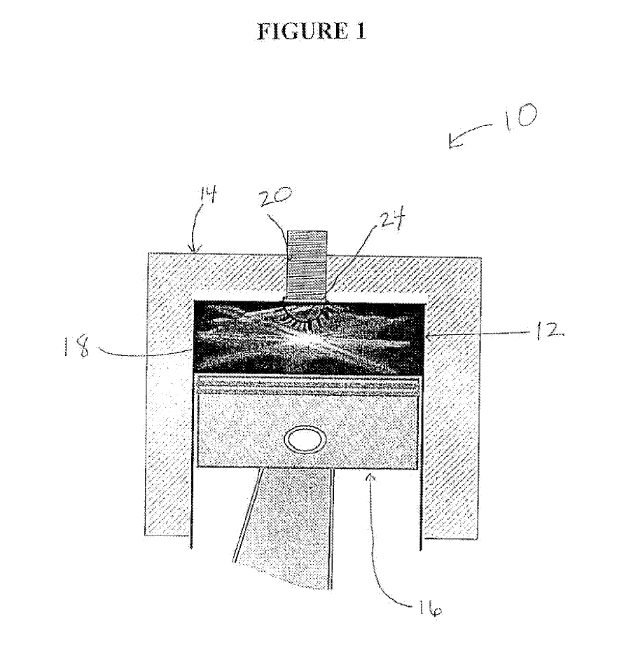

FIG. 1 is a cross-sectional view showing the combustion chamber defining portion of a single cylinder of an engine.

### DETAILED DESCRIPTION OF THE INVENTION

While the invention is susceptible to various modifications and alternative forms, specific embodiments thereof are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

The present invention is a directed to a method of controlling combustion of an air-fuel charge in a piston engine having at least one combustion chamber. It has been found that combustion of an air-fuel charge in a piston engine having at least one combustion chamber may be controlled by adding a combustion initiating additive and initiating combustion with a light source, or alternatively, initiating combustion with a light source and a spark or heat ignition source, such as a spark plug or a glow plug.

In FIG. 1, numeral 10 generally indicates a portion of an engine including a cylinder 12 closed at one end by a cylinder head 14. The cylinder carries a reciprocal piston 16 which defines with the cylinder and cylinder head a variable combustion chamber 18 that varies in volume with the movement of the piston. Conventional intake and exhaust valves, or other charge intake and exhaust means not shown, are provided for admitting the air-fuel charge into the combustion chamber and discharging combustion products there from.

In accordance with the invention, the engine in FIG. 1 further includes an opening 20 extending through the cylinder head. Within the opening there is mounted at least one light source 24. In another embodiment, at least one light source 24 is mounted on at least one surface of the cylinder.

Typically, the HCCI engine is designed to operate to the extent possible on a homogeneous charge compression ignition (HCCI) combustion mode, wherein a homogeneous air-fuel charge is drawn into the cylinder, or formed within the cylinder, on the piston intake stroke. The homogeneous air-fuel charge is subsequently compressed on the compression stroke to the point where ignition occurs due to increased temperature of the charge as it is compressed to ignition temperature near the end of the compression stroke. Ignition is timed to provide continuing combustion and completion thereof within a desired period of piston motion near its top dead center position.

The engine should be designed to provide for compression ignition of the charge without substantial additional heating when operating at a full power condition in which the air-fuel mixture is sufficiently rich for auto ignition under maximum load and temperature conditions.

However, sometimes combustion in an HCCI engine is neither precise nor predictable. In such instances of unpredictability or imprecision, a combustion initiating additive will be added to the air-fuel charge. The combustion initiating additive may be pre-mixed with a hydrocarbon fuel thereby producing a fluid fuel mixture which is then mixed with a gaseous medium containing oxygen thereby producing an air-fuel charge which is then; added to at least one combustion chamber. The air-fuel charge will be compressed with a piston in at least one combustion chamber. The air-fuel charge is then ignited with a light source.

Alternatively, the gaseous medium containing oxygen is added to at least one combustion chamber. The combustion initiating additive may be pre-mixed with at least one hydrocarbon fluid fuel thereby producing a fluid fuel mixture which is then added to the combustion chamber which already contains the gaseous medium containing oxygen. Again, the mixture of the fluid fuel mixture and the gaseous medium produces an air-fuel charge. The air-fuel charge will be compressed with a piston in at least one combustion chamber. The air-fuel mixture is then ignited with a light source.

The basis for development of the present invention is the recognition that a combustion initiating additive ca n be added to an air-fuel mixture; the combustion initiating additive and air-fuel mixture can be ignited with a light source; and combustion in a combustion chamber can be controlled wherein air-fuel mixtures of varying ignitability are used to vary power output of the engine. HCCI combustion is a chain reaction involving initiation, propagation, and termination steps. The time required to initiate the reaction is a function of temperature. If it is hot enough, the air-fuel charge initiates and burns quickly. If it is slightly cooler, the mixture takes a longer time to begin burning as well as to complete combustion. If it is too cold it will never ignite. The addition of a combustion initiating additive promotes initiation in HCCI combustion.

The compressed charge temperature in a compression ignition engine results from the initial charge temperature being increased by the heat of compression. However, when increasingly weaker air-fuel mixtures are provided at lower power outputs, additional heat must be provided to the cylinder charge in order to ignite the weaker charges and initiate their continuing combustion. However, the inventors have discovered that additional heat does not have to be provided to the cylinder in order to initiate combustion; instead, a combustion initiating additive may be added to the air-fuel charge and ignited, therein initiating combustion.

Combustion Initiating Additive

The inventors have discovered that a preferred combustion initiating additive is a free radical initiator. Not wishing to be bound by any particular theory, it is believed that these free radical initiators are exposed to an intense energy source, or light source, such as an ultraviolet or purple light. The light breaks apart the free radical initiator by photodecomposition, thereby creating free radicals to start the ignition process. The introduction of the light source can then be timed to maximize the performance of the HCCI engine.

The free radical initiators must be stable in the fuel while also being able to decompose when introduced to an intense energy source. Preferably, the free radical initiators, or combustion initiating additives, of the present invention include but are not limited to organic peroxides azides, hydrazines, and ketones. More preferred, the combustion initiating additive is an aromatic ketone having an adsorption band in the ultraviolet part of the electromagnetic spectrum with a wavelength lower than about 400 nanometers (nm), even more preferred the wavelength is less than about 380 nm. Even more preferred, the aromatic ketone is 4,4′-bis(diethylamino)benzophenone, 4,4′-bis(dimethylamino)bensophenone, 4-(dimethylamino)benzophenone, or acetophenone. Most preferred, the aromatic ketone is acetophenone.

In one embodiment of the present invention, the combustion initiating additive is either a ketone or a ketone combined with at least one of an organic peroxide, azide or hydrazine.

The amount of free radical initiator or combustion initiating additive added to the fuel must be adequate to start the ignition process with an intense source of light of less than 400 nm directed into the cylinder of an HCCI engine. Preferably, the amount of combustion initiating additive employed is no more than 10,000 ppm. More preferred the amount of combustion initiating additive employed is no more than 1,000 ppm. Even more preferred, the amount of combustion initiating additive employed is no more than 100 ppm. Most preferred the amount of combustion initiating additive employed is no more then 5 ppm.

Hydrocarbon Fluid Fuel

The combustion initiating additive may be added to a hydrocarbon fluid fuel such as, but not limited to, liquefied petroleum gas (LPG), gasoline, jet fuel, diesel fuel, hydrotreated naptha, hydrotreated mid-distillates, Fischer Tropsch liquids, and mixtures thereof.

In one embodiment, the combustion initiating additive is premixed with the hydrocarbon fluid fuel thereby producing a fluid fuel mixture. The fluid fuel mixture may be mixed either with a gaseous medium containing oxygen, such as air, prior to being added to a combustion chamber, thereby producing an air-fuel charge.

In the alternative, the gaseous medium containing oxygen is added to a combustion chamber. The fluid fuel mixture is then added to the chamber by any method that is well known in the art, such as, but not limited to, fuel injection, thereby producing an air-fuel charge.

The air-fuel charge may be either homogenous or stratified. In a stratified air-fuel charge engine, two or more distinct and separate fuel-air mixtures are introduced in the combustion chamber prior to compression and then ignition. These mixtures are kept largely separate by virtue of how, when or where they are introduced into the combustion chamber. By contrast, in a homogenous air-fuel charge engine, the fuel-air mixture is not separate and distinct.

Light Source

A light source is used to ignite the combustion initiating additive. Preferably the light source has a peak wavelength of no more than about 400 nanometers, more preferably the peak wavelength is no more than about 380 nanometers; and the light source has a power output greater than 0.1 mW, more preferably the power output is greater than 1 mW.

Preferably, the light source is a light emitting diode, a mercury vapor discharge, a low pressure rare gas discharge, or a diode laser. More preferably the light source is a light emitting diode.

One or more light sources may be attached to each combustion chamber or the light source may be distributed to the combustion chamber(s) as a single point source or it may be distributed using at least one fiber optic cable that conducts light from a common source to at least one combustion chamber.

The distribution of the light source is controlled electronically, mechanically or both electronically and mechanically.

Additionally, the light source introduced into the combustion chamber may be diffused by a lens.

The light source is affixed to at least one surface of the cylinder of the piston engine. The light source is introduced into the top of the combustion chamber, into the side surface of the combustion chamber or into both the top and the side of the combustion chamber.

Additive Package

Furthermore, the combustion initiating additive may be combined with a propagating additive and an inhibiting additive. Propagating additives include, but are not limited to, organic peroxides, preferably aromatic peroxides, azides and hydrazine compounds. The inhibiting additive is added to suppress the decomposition of the fluid fuel which may occur by being exposed to such light sources as sunlight. It is importance that the inhibitor block deposit forming ultraviolet light while the combustion initiating additive containing fuel is being stored and transported, but that the inhibitor not block the wavelength of light being used as the ignition source. Thus, for example, if acetophenone is used as the combustion initiating additive, it would be important to use an inhibiting additive that adsorbs light less than about 350 nm.

While the invention has been described by reference to certain preferred embodiments, it should be understood that numerous changes could be made within the spirit and scope of the inventive concepts described. Accordingly, it is intended that the invention not be limited to the disclosed embodiments, but that it have the skill scope permitted by the language of the following claims.

Other embodiments will be obvious to those skilled in the art.

What is claimed is:

1. A method of controlling combustion of an air-fuel charge in a piston engine having at least one combustion chamber comprising:
(a) mixing at least one hydrocarbon fluid fuel and no more than about 10,000 ppm of at least one combustion initiating additive to there by produce a fluid fuel fixture;
(b) combining the fluid fuel mixture with a gaseous medium containing oxygen thereby producing an air-fuel charge;
(c) supplying the air-fuel charge to the at least one combustion chamber;
(d) compressing the air-fuel charge with a piston in the at least one combustion chamber; and
(e) igniting the air-fuel charge with at least one light source.

2. The method according to claim 1 wherein the gaseous medium is air.

3. The method according to claim 1, wherein the air-fuel charge is also ignited with a spark ignition source.

4. The method according to claim 1, wherein the at least one combustion initiating additive comprises a ketone.

5. The method according to claim 1, wherein the at least one combustion initiating additive comprises a ketone and at least one of an organic peroxide, an azide, or a hydrazine.

6. The method according to claim 4, wherein the ketone is an aromatic ketone.

7. The method according to claim 6, wherein the aromatic ketone is selected from a group consisting of 4,4′-bis(diethylamino)benzophenone, 4,′4-bis(dimethylamino)bensophenone, 4-(dimethylamino)benzophenone, and acetophenone.

8. The method according to claim 7, wherein the aromatic ketone is acetophenone.

9. The method according to claim 1, wherein the at least one combustion initiating additive has an adsorption band with a wavelength no more than about 400 nanometers.

10. The method according to claim 9, wherein the adsorption, band has a wavelength of no more than about 380 nanometers.

11. The method according to claim 1, wherein no more than about 1,000 ppm of the at least one combustion initiating additive is mixed with the fluid fuel.

12. The method according to claim 11, wherein no more than about 100 ppm of the at least one combustion initiating additive is mixed with the fluid fuel.

13. The method according to claim 1, wherein the hydrocarbon fluid fuel is selected from liquefied petroleum gas, gasoline, jet fuel, aviation fuel, diesel fuel, hydrotreated naphtha, hydrotreated mid-distillates, Fischer Tropsch liquids, and mixtures thereof.

14. The method according to claim 1, wherein the light source comprises a light emitting diode, a mercury vapor discharge, a low-pressure rare gas discharge, or diode laser.

15. The method according to claim 1, wherein each combustion chamber has its own light source.

16. The method according to claim 1, wherein the light source is distributed to at least one combustion chamber.

17. The method according to claim 1, wherein at least one fiber optic cable distributes the light source from a common source to at least one combustion chamber.

18. The method according to claim 16, wherein the distribution of the light source is controlled electronically, mechanically or both electronically and mechanically.

19. The method according to claim 1, wherein the at least one light source is affixed to at least one surface on the combustion chamber.

20. The method according to claim 19, wherein the at least one light source is introduced into the top of the combustion chamber, into the side of combustion chamber or into both the top and the side of the combustion chamber.

21. The method according to claim 19, wherein the at least one light source introduced into the combustion chamber is diffused by a lens.

22. The method according to claim 1, wherein the air-fuel charge is either homogenous or stratified.

23. The method according to claim 1, wherein the air-fuel charge is also ignited with a spark ignition source.

24. A method of controlling combustion of an air-fuel charge in a piston engine having at least one combustion chamber comprising:
(a) mixing at least one hydrocarbon fluid fuel and no more than about 10,000 ppm of at least one combustion initiating additive to thereby produce a fluid fuel mixture;
(b) supplying a gaseous medium containing oxygen to the at least one combustion chamber;
(c) supplying the fluid fuel mixture to the at least one combustion chamber and mixing the fluid fuel mixture with the gaseous medium containing oxygen thereby producing an air-fuel charge;
(d) compressing the air-fuel charge with a piston in the at least one combustion chamber; and
(e) igniting the air-fuel charge with a light source.

25. The method according to claim 24, wherein the air-fuel charge is also ignited with a spark ignition source.

26. The method according to claim 24, wherein the air-fuel charge is either homogenous or stratified.
